(19) United States
(12) Patent Application Publication
(10) Pub. No.: US 2015/0136318 A1
(43) Pub. Date: May 21, 2015

(54) SYSTEM AND METHOD OF CONTROLLED BONDING MANUFACTURING

(71) Applicant: Quartermaster, LLC, Lowell, AR (US)

(72) Inventor: Simeon E. Tiefel, Lowell, AR (US)

(21) Appl. No.: 14/509,514

(22) Filed: Oct. 8, 2014

Related U.S. Application Data
(60) Provisional application No. 61/905,581, filed on Nov. 18, 2013.

(51) Int. Cl. B32B 38/00

(52) U.S. Cl. CPC B32B 38/0008; B32B 2310/00
USPC 156/272.8; 156/351

(57) ABSTRACT

A controlled-bonding manufacturing system for creating objects from a material sheet without the use of adhesives. The system comprises a flat base, a laser welding assembly, a feeding element, and a computing element. The flat base is adapted to receive a plurality of layers of the material sheet layered thereon. The laser welding assembly is adapted to move relative to the flat base. The laser welding assembly comprises a welder housing, a substantially transmissive roller rotatably coupled to the welder housing, and a welding laser adapted to emit a laser beam through at least a portion of the transmissive roller. The absence of air, the mechanical pressure, and the emitted laser beam welds at least a portion of a top layer of the material sheet to at least one other layer of the material sheet.

### RELATED APPLICATIONS

This application claims priority benefit, with respect to all common subject matter, of U.S. Provisional Patent Application No. 61/905,581, filed Nov. 18, 2013, and entitled “LAMINATE OBJECT MANUFACTURING SYSTEM AND METHOD” (“the '581 Provisional Application”). The disclosure of the '581 Provisional Application is hereby incorporated herein by reference in its entirety.

### BACKGROUND

1. Field

Embodiments of the invention relate to three-dimensional (3D) manufacturing. More specifically, embodiments of the invention relate to controlled-bonding manufacturing by laser welding.

2. Related Art

Three-dimensional (3D) printers perform additive manufacturing, which is the creation of 3D objects via placement of layers of material in a desired shape. The 3D printer creates the object by adding layer upon layer until the object's shape is complete. Other manufacturing methods are known, such as milling and injection molding. In milling, unwanted material is removed from a block of material to render the object. Milling produces objects with a high material strength, but there are many shapes that are unattainable through milling. Injection molding creates objects through injecting a liquid form of the material into a mold of a desired shape of the object, and allowing the material to cool into the solid object. However, injection molding is only economically feasible for mass-produced objects, because it requires the creation of a large mold only useful for that specific object.

The 3D printers of the prior art attempt to overcome these shortcomings but provide serious shortcomings of their own. While there are many types of 3D printers, most can be broadly categorized as ‘granular’ or ‘laminate.’ Granular 3D printers create objects from small particulates that are fused together (sometimes suspended in a liquid). Laminate 3D printers fuse multiple layers of material together using an adhesive and cutting away the excess.

The first shortcoming of known 3D printers is a lack of density in the formed object. The object does not have a material strength that allows for repeated use of the object or for use under high-stress conditions. The lack of density is especially problematic in granular 3D printers, where the achievable material density is too low for most applications. The second shortcoming is uniformity of bonds. There is no control over the degree to which the material is combined. A third shortcoming of 3D printers is a lack of material uniformity. Especially in 3D printers that layer materials, the adhesives used to hold the object together require that the created object not be a pure material. A fourth drawback of known 3D printers is excessive waste. In laminate 3D printers, for example, large portions of the sheet of material are cut away, which results in a high amount of waste material. A fifth shortcoming of known 3D printers is the need to cure the object after completion, which is time consuming and leads to changes in the object's shape. A sixth shortcoming of known 3D printers is that the raw materials of manufacture are expensive and produced mainly for use in 3D printers.

### SUMMARY

Embodiments of the invention solve the above-mentioned problems by providing a controlled-bonding manufacturing system and a laser welding assembly that creates objects of a uniform material, without the use of adhesives. The created objects are very dense, especially as compared to the objects created by 3D printers of the prior art. These objects may also have various bond strengths at different locations on the object to control where and how intended failures will occur. The user can input the desired bond strengths when designing the object via prototyping software. Further, the object has little or no need to cure as it is cooled during the manufacturing process. The object is created from commercially available film that is much less expensive than standard 3D printer materials.

A first embodiment of the invention is directed to a controlled-bonding manufacturing system for creating objects from a material sheet without the use of adhesives. The system broadly comprises a flat base, a laser welding assembly, a feeding element, and a computing element. The flat base is adapted to receive a plurality of layers of the material sheet layered thereon. The laser welding assembly is adapted to move relative to the flat base. The laser welding assembly broadly comprises a welder housing, a substantially transmissive roller rotatably coupled to the welder housing, and a welding laser adapted to emit a laser beam through at least a portion of the transmissive roller. The mechanical pressure exerted by the transmissive roller and the emitted laser beam weld at least a portion of a top layer of the material sheet to at least one other layer of the material sheet. The feeding element provides the material sheet. The computing element controls the movement of the laser welding assembly and the firing of the welding laser.

A second embodiment of the invention is directed to the laser welding assembly discussed above. The laser welding assembly may supplement or replace components of existing 3D printers.

A third embodiment of the invention is directed to a method of manufacturing an object utilizing the controlled-bonding manufacturing system to weld layers of the object together.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is a perspective view of one embodiment of the controlled-bonding manufacturing system;

FIG. 2 is a top view of the embodiment of the controlled-bonding manufacturing system from FIG. 1;

FIG. 3 is a side view of the embodiment of the controlled-bonding manufacturing system of FIG. 1;

FIG. 4 is a vertical cross-section view through the line 4-4 of FIG. 3 and particularly illustrating a hollow transmissive roller of the controlled-bonding manufacturing system;

FIG. 5 is a perspective view of one embodiment of the laser welding assembly of the controlled-bonding manufacturing system;

FIG. 6 is an exploded view of the laser welding assembly of FIG. 5;

FIG. 7 is a schematic view of the components of the controlled-bonding manufacturing system; and

FIG. 8 is a perspective view of another embodiment of the controlled-bonding manufacturing system in which the transmissive roller is not hollow.

The drawing figures do not limit the current invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

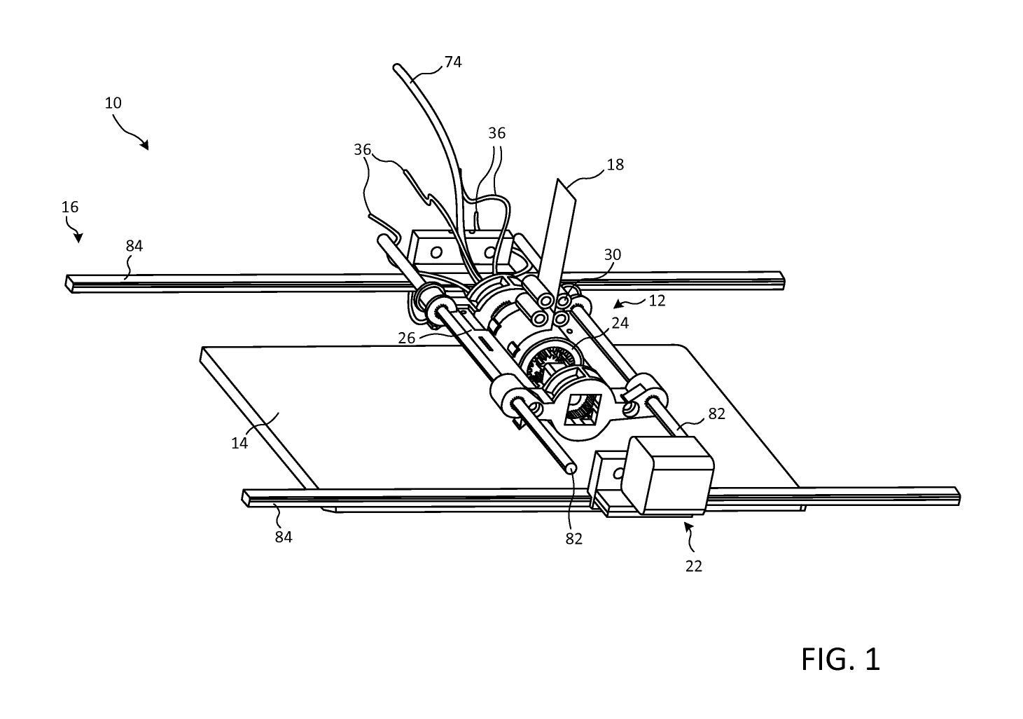

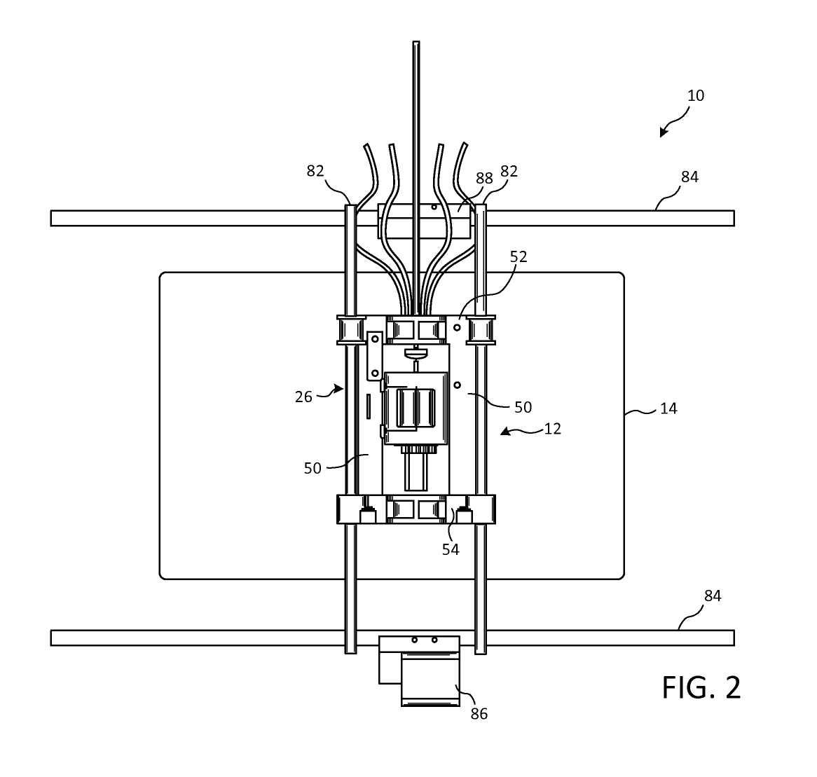

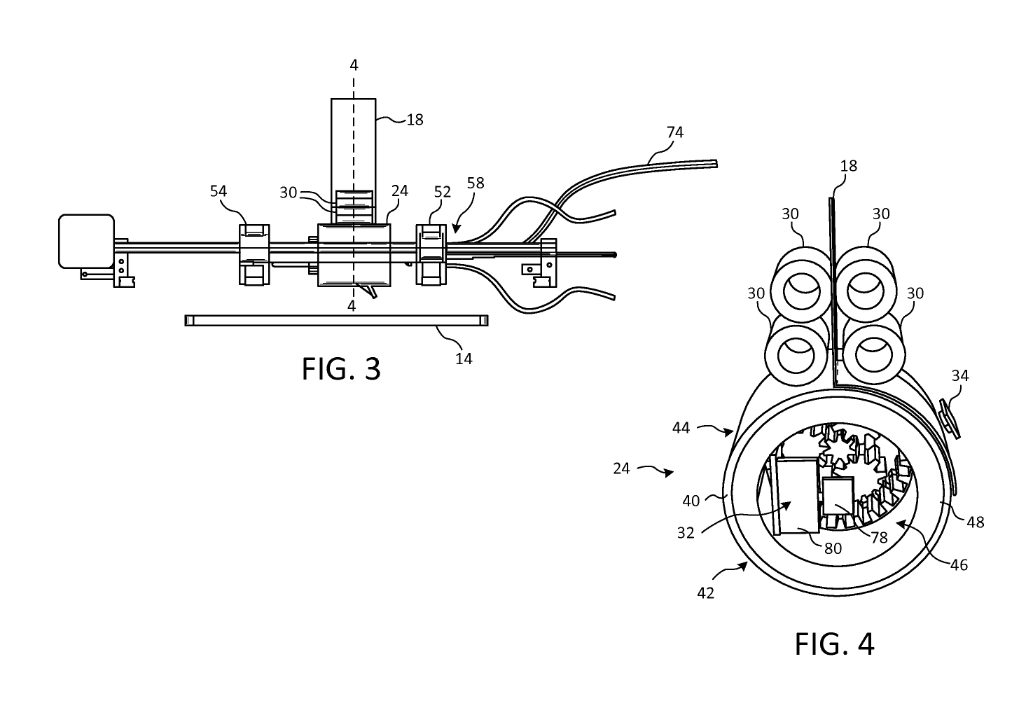

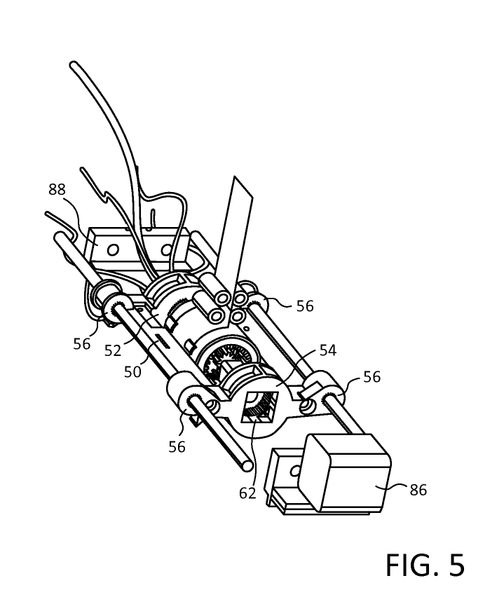

Turning to the figures, and specifically FIGS. 1-3 and 7, a controlled-bonding manufacturing system 10 of embodiments of the invention will now be discussed. The controlled-bonding manufacturing system 10 generally comprises a laser welding assembly 12, a flat base 14, a feeding element 16 to provide a material sheet 18, a computing element 20 to control a method of manufacturing, and at least one motor 22 to control the movement of the laser welding assembly 12.

The laser welding assembly 12 generally comprises a transmissive roller 24, a welder housing 26 for rotatably securing the transmissive roller 24, at least one guide roller 30, and a welding laser 32. Other embodiments of the laser welding assembly 12 further comprise at least one optical sensor 34. The laser welding assembly 12 may also comprise at least one cable 36. The at least one cable 36 may provide power, photons, and/or communications. The laser welding assembly 12 may also comprise a heating element (not illustrated).

A detailed discussion of the structure of each of the components of the system 10 will be discussed below. However, as an overview, in embodiments of the invention the controlled-bonding manufacturing system 10 generally operates as follows. The material sheet 18 is fed from the feeding element 16 to the guide rollers 30. The guide rollers 30 transfer the material sheet 18 to the transmissive roller 24. The transmissive roller 24 rolls the material sheet 18 onto the flat base 14 and at least one lower material sheet 18. The welding laser 32 then selectively engages to weld the two layers of the material sheet 18 together. Thus, embodiments of the invention essentially weld a second, top layer material sheet 18 on a first, bottom layer material sheet 18. When a third layer material sheet is placed on top of the second, top layer material sheet, the second layer material sheet becomes the lower layer material sheet relative to the third layer material sheet. This process is successively repeated hundreds to thousands of times to form the object. The welding laser 32 is positioned with respect to the transmissive roller 24 to emit a focused laser beam through at least a portion of the transmissive roller 24. The laser beam precisely welds the second, top layer material sheet to the first, bottom layer material sheet. The welding laser 32 may also ablate, i.e., vaporize, portions of the material sheet 18. The system 10 then repeats the process of laying the third layer material sheet over the now-welded first and second layer material sheets and welding the third layer material sheet to the second layer material sheet. In embodiments of the invention, the welding process does not extend to the already-welded first and second layers but is instead focused only on the second and third layers. Again, this process is repeated for successive layers.

The controlled-bonding manufacturing system 10 can be used to create a wide variety of objects 38. The object 38 is created by the welding laser 32 welding and ablating numerous layers of the material sheet 18 to create the desired object 38. The welding laser 32 is controlled by the computing element 20. A user inputs an electronic model into the computing element 20 that depicts the desired shape of the object 38, as well as any desired bond strengths.

Embodiments of the invention can be applicable to many fields of use. The fields of use include, but are not limited to, part manufacturing, repair part manufacturing, modeling, etc. While most objects created by 3D printers of the prior art are useful mainly for rapid protoyping, objects constructed utilizing the controlled-bonding manufacturing system 10 of embodiments of the invention are useful as production-quality parts within machinery, for example, similar to an injection-molded part. The density and uniformity of the object 38, discussed below, allow the object 38 to be used in numerous settings and applications.

The flat base 14 provides a platform upon which the object 38 is created. In some embodiments, the flat base 14 is a component of the controlled-bonding manufacturing system 10. The flat base 14 may be rectangular, square, circular, or another shape. The flat base 14 is substantially flat so as to present a manufacturing plane. In other embodiments, the flat base 14 is not a component of the controlled-bonding manufacturing system 10 but is instead a substantially flat surface upon which the system 10 forms the object. The flat base 14 may be an existing object or part, and the object 38 created is added to the existing part. The flat base 14 may have sidewalls (not illustrated) and may be filled with water or another liquid to aid in cooling the object 38 as it is manufactured. In other embodiments, the flat base 14 is filled with granular materials.

In embodiments of the invention, the flat base 14 is movable. As the object 38 is created, the flat base 14 slowly lowers vertically to allow the laser welding assembly 12 to remain at the same level along a vertical axis. The lowering of the flat base 14 is performed by a motor and/or a piston (not illustrated). In some embodiments, the flat base 14 also moves laterally such that the transmissive roller 24 rolls horizontally along the material sheet 18 atop the flat plate as the flat base 14 moves. The flat base 14 may also move to allow the welder housing 26 to move out of contact with the material sheet 18 atop the flat base 14. This may be desirable to change the type of material sheet 18, change the direction in which the laser welding assembly 12 moves, create voids or channels in the object 38, allow the object 38 to cool, allow the completed object 38 to be removed from the flat base 14, etc.

The material sheet 18 is the substance from which the object 38 is created. In some embodiments, the material sheet 18 is elongated and feeds through the laser welding assembly 12, such that the material sheet 18 is welded and/or ablated as it is placed atop the other layers of the material sheet 18. In some embodiments, there is a plurality of material sheets 18, each of which is successively layered upon the other by the feeding element 16. Each of the plurality of material sheets 18 may be substantially the same size and shape as the flat base 14. Alternatively, a size or, specifically, an area of the material sheets 18 may be different from one another. In yet other embodiments, there is a single flat material sheet 18 on the flat base 14 and an elongated material sheet 18 supplied via the laser welding assembly 12, such that upon the first application of the material sheet 18 via the laser welding assembly 12, it is welded to the single flat material sheet 18 already upon the flat base 14.

In embodiments, the material sheet 18 is formed of thermoplastic, wax, elastomer, metal-infused polymer composites, electro-active polymers, grapheme-based composites, optical-grade lens material, polyvinyl chloride (PVC), or other polymers. The material sheet 18 may also be formed of a thin metal sheet such as aluminum foil or tin foil. The material sheet 18 is thin; for example, it may be 0.01 mm to 0.7 mm thick, less than 0.2 mm thick, less than 0.7 mm thick, less than 1 mm thick, less than 2 mm thick, less than 4 mm thick, or less than 10 mm thick. Thin layers of the material sheet provide higher quality and greater resolution in the object 38. Because the material sheet 18 is thin, the laser welding assembly 12 is capable of quickly and uniformly liquefying the entire thickness of the material sheet 18 for welding.

The material sheet 18 is inherently dense, for example it may be 100% dense, at least 99.9% dense, at least 99% dense, at least 95% dense, or at least 90% dense. The object 38 created by the laser welding assembly 12 is also highly dense, due to the pressure and heat selectively placed upon the material sheet 18, as discussed below. As such, the object 38 may be 100% dense, at least 99.9% dense, at least 99% dense, at least 95% dense, or at least 90% dense. These high-density objects 38 provide an advantage in that the object is more durable (e.g., less resistive to undesired or unintended breaking, cracking, or cleaving) and heavier.

In some embodiments, a single material sheet 18 is utilized to form the entirety of the object 38. In other embodiments, material sheets 18 of more than one type are used to form the object 38. This provides the advantage of allowing the creation of non-unitary objects 38. It should be appreciated that a number of material sheets 18 used in a particular object is dependent on a size and shape of the object. However, given the thinness of the material sheets 18, it is expected that most any object will be comprised of at least 100 material sheets 18, at least 1,000 material sheets 18, at least 5,000 material sheets 18, or at least 10,000 material sheets 18. Thus, embodiments of the invention are operable to lay hundreds to thousands of material sheets 18, one on top of another, and successively bond the sheets as they are laid one on top of another to form the object.

Embodiments of the invention provide the advantage of forming the object 38 of a pure material, without the aid of reactants, adhesives, or other catalyzing systems. The material sheet 18 is bonded to another material sheet 18 (or another layer of the same material sheet 18) by a combination of mechanical pressure from the transmissive roller 24, a lack of air at the point of the weld, and energy from the welding laser 32. The molecules of at least one layer of the material sheet 18 temporarily liquefy and adhere to the lower layers. The resultant object 38 has a strong bond and a high density, as discussed herein.

Embodiments of the invention are also operable to laminate different materials together. Materials that share similar molecular properties can be combined into a variety of shapes and strengths. The different materials are welded together, instead of using adhesives that are prone to failure. In some embodiments, the two materials are partially welded by the system 10, and a follow-on method or procedure fully sets the object 38. The follow-on method or procedure may include steps such as heating an oven to a certain temperature, placing the partially-welded object 38 into the oven, leaving the object 38 in the oven for a certain period of time, and removing the object 38 for cooling.

As noted above, the layering of the material sheets 18 creates the object 38. The computing element 20 controls the welding laser 32 to selectively weld certain sections and ablate certain sections of the material sheet 18 to produce the desired shape for that specific layer of material sheet 18. The process is then repeated to produce the desired shape for each layer. Upon completion, each layer of the material sheet 18 has been welded in desired areas and ablated in undesired areas.

The components of the laser welding assembly 12 will now be discussed. The transmissive roller 24 is rotatably coupled to the welder housing 26. The transmissive roller 24 is formed of glass or a clear polymer. Embodiments of the transmissive roller 24 are substantially transparent or translucent in at least a portion of its surface. The laser beam is guided, either directly or indirectly, through at least a portion of the transmissive roller 24. In particular, the transmissive roller 24 is transparent or translucent at least in the portion through which the laser beam is to be transferred. The transmissive roller 24 presents an outer surface 40 that is substantially smooth for at least a portion. Because the transmissive roller 24 is substantially transmissive in at least a portion, most of the energy from the laser beam passes through the transmissive roller 24 and is transferred to a portion of the material sheet 18.

In embodiments of the invention, the transmissive roller 24 is substantially a cylinder in shape, presenting two circular bases 42 and a body 44 therebetween. The cylindrical roller 24 is oriented such that a length of the body 44 lies parallel to the manufacturing plane created by the flat base 14. The transmissive roller 24 is then configured to roll across the flat base 14. The laser beam is emitted substantially straight down through the transmissive roller 24, perpendicular to the cylindrical body 44. Because the transmissive roller 24 is substantially transparent and the laser beam is a highly-focused beam of energy, there is minimal refraction and reflection within the transmissive roller 24.

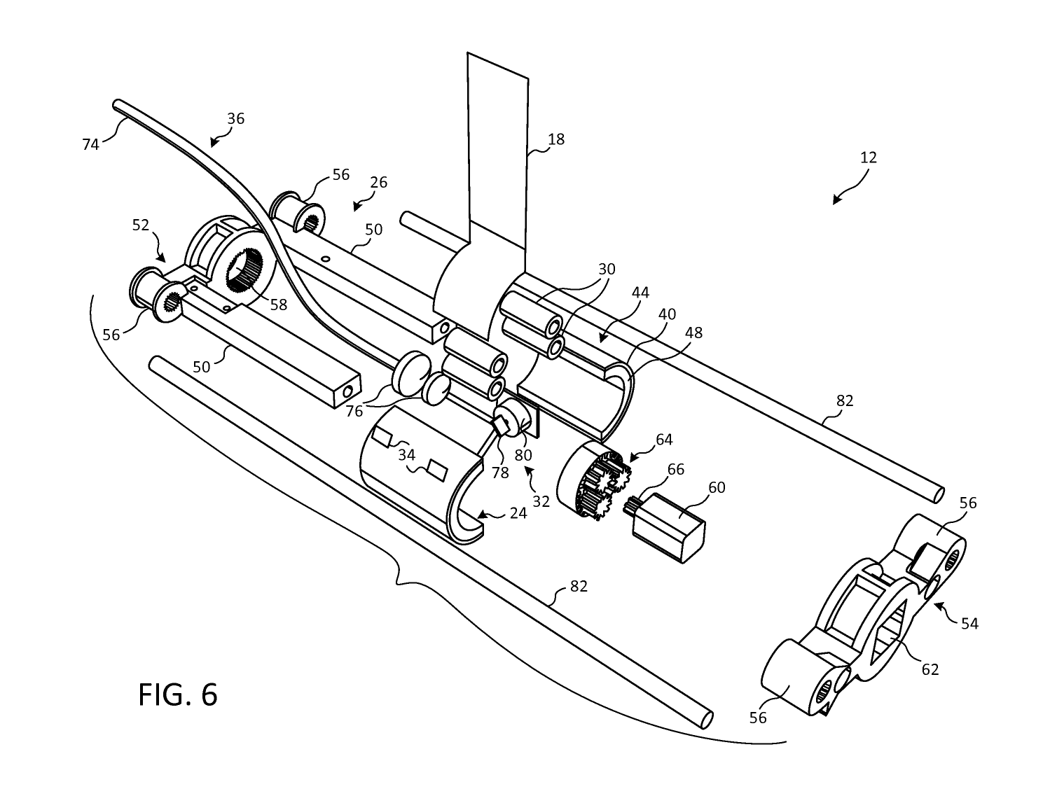

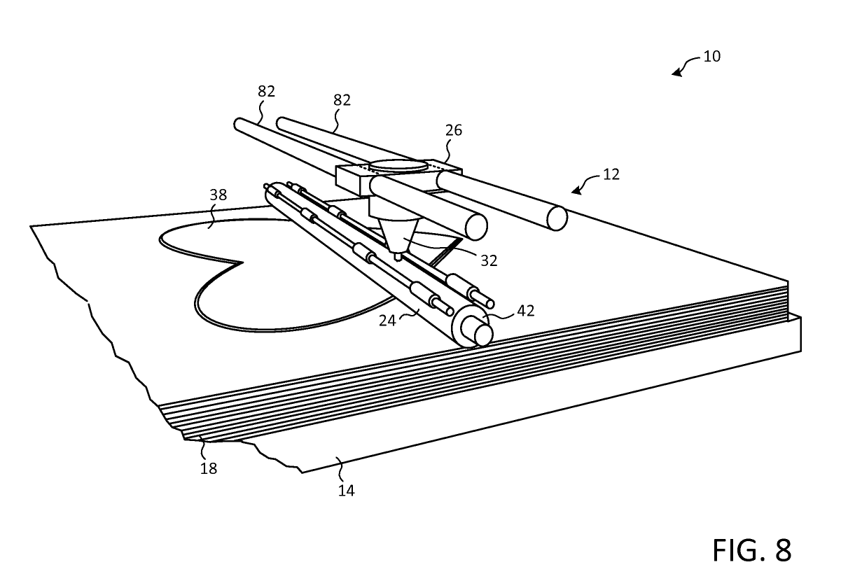

In some embodiments, as best illustrated in FIGS. 4 and 6, the transmissive roller 24 body 44 is hollow to present a void 46 and a circular wall 48. At least a portion of the welding laser 32 is disposed within the void 46 and adapted to emit the laser beam down through the circular wall 48. During operation, as discussed below, the transmissive roller 24 rotates around at least a portion of the welding laser 32 during the method of manufacturing. In other embodiments, as illustrated in FIG. 8 and discussed below, the transmissive roller 24 is not hollow, but is instead solid. In these embodiments, the welding laser 32 is disposed above the transmissive roller 24, and the laser beam of the welding laser 32 travels through the entire transmissive roller 24.

The outer surface 40 of the transmissive roller 24 has non-stick properties. These anti-sticking properties prevent the material sheet 18 from sticking to the transmissive roller 24 during the welding process. At the point where the laser beam is welding a portion of the top layer of the material sheet 18 to at least one other layer of the material sheet 18, at least the top layer of the material sheet 18 is temporarily liquefied. It is therefore desirable that the liquefied material adheres to the other layer of the material sheet 18 and not to the transmissive roller 24. If the transmissive roller 24 is too sticky, the transmissive roller 24 will adhere to the top layer of the material sheet 18, forcing it to de-laminate or peel from the other layers of the material sheet 18. Even if it does not fully destroy the weld, it can weaken the bond between the two layers.

The non-stick properties of the outer surface 40 of the transmissive roller 24 may be an inherent property of the material from which the transmissive roller 24 is formed, or it may be a property of a coating applied to the transmissive roller 24. In either case, the non-stick property is mechanically stable and present in a high-heat environment.

In some embodiments of the invention, an optical-grade (i.e., transparent or translucent) silicone coating provides the non-stick properties of the transmissive roller 24. Silicone resists heat, which allows the welding of materials with a high melting point. Silicone also has a low surface energy, which allows it to remove itself from the molten material gently so as not to disturb the formation of the object 38. Silicone is not completely non-stick. It does have some adhesive properties that allow the material sheet 18 to smoothly adhere to the transmissive roller 24 by simple contact pressure. This light adhesion ensures the proper placement of the material sheet 18 and prevents air bubbles from being present between the transmissive roller 24 and the material sheet 18.

In other embodiments, polytetrafluoroethylene (also known as “Teflon”) is used for the coating to provide the non-stick properties to the transmissive roller 24. In yet other embodiments, the coating is formed of transparent or translucent anodized aluminum, ceramics, enamel, etc. In still further embodiments, a mixture or composite of coatings provides the non-stick properties of the transmissive roller 24.

As noted above, in some embodiments the non-stick properties are inherent to the material that forms the transmissive roller 24 and are therefore not a coating. In one embodiment, at least a portion of the transmissive roller 24 is formed of a silicone mixture or composite. This provides the silicone properties to the transmissive roller 24 without a coating. As discussed above, the silicone is optical-grade, such that it is transparent or translucent so as not to interfere with the transmission of the laser beam.

At least a portion of the transmissive roller 24 is substantially transparent, which allows light to pass through the transmissive roller 24 without being scattered. As the photons of the laser beam contact the surface of the transmissive roller 24, the majority of the photons is transmitted through to the material sheet 18, instead of being absorbed or reflected. To minimize light scattering, the material and/or coating of the transmissive roller 24 is adapted to the wavelength of the light from the laser beam. In another embodiment, the wavelength of the light of the laser beam is adapted to the material and/or coating of the transmissive roller 24.

The transmissive roller 24 exerts a mechanical pressure on the material sheet 18. The mechanical pressure may cause the transmissive roller 24 to deform slightly along the layers of the material sheet 18. The mechanical pressure removes air from the location of the weld and assists in welding the material sheet 18 to at least one lower layer of the material sheet 18. The mechanical pressure also removes foreign substances, such as air or water, from between the layers of the material sheet 18. The removal of foreign substances ensures that the object 38 is substantially uniform and monolithic, and helps to form a proper weld. In some embodiments, the mechanical pressure is generated by the weight of the transmissive roller 24 and/or the laser welding assembly 12. In other embodiments, the mechanical pressure is generated by the relative positions of the flat base 14 and the transmissive roller 24, such that a force is exerted on the material sheet 18 that is situated between the flat base 14 and the transmissive roller 24. The mechanical pressure has the advantage of helping to ensure that the material sheet 18 welds to the lower layer of the material sheet 18.

The transmissive roller 24 is rotatably coupled to the welder housing 26. The welder housing 26 encompasses or provides a base for many of the components of the laser welding assembly 12. As shown in FIG. 6, the welder housing 26 is substantially elongated parallel to the body 44 of the transmissive roller 24. The welder housing 26 is adapted to be moved parallel to the manufacturing plane of the flat base 14. In some embodiments, the welder housing 26 moves via a set of tracks and motors, as discussed below. In another embodiment, the welder housing 26 moves via an articulating robotic arm, not illustrated. In yet another embodiment, the welder housing 26 is stationary and the flat base 14 moves relative to the housing 26.

Embodiments of the welder housing 26 comprise a traversing segment 50, a first end cap 52, a second end cap 54, and at least one track-interfacing segment 56. Either or both of the first end cap 52 and the second end cap 54 may comprise a cable receptor 58 for receiving the at least one cable 36. Either or both of the first end cap 52 and the second end cap 54 may also support a roller motor 60 via a motor mount 62, discussed below.

The traversing segment 50 is elongated parallel to the body 44 of the transmissive roller 24. The traversing segment 50 is generally the same length or longer than the body 44 of the transmissive roller 24. The traversing segment 50 of the welder housing 26 may be located on any side of the transmissive roller 24. As shown in FIG. 6, the traversing segment 50 may comprise two parallel portions separated by a distance that is approximately the same as, or slightly greater than, the diameter of the cylindrical body 44 of the transmissive roller 24. This allows the transmissive roller 24 to rotate within the traversing segment 50.

The first end cap 52 and the second end cap 54 are each rotatably associated with, and in embodiments coupled with, the transmissive roller 24 and the traversing segment 50. As such, the first end cap 52 and the second end cap 54 are secured a certain distance apart which is approximately the same as, or slightly longer than, the body 44 of the transmissive roller 24. The first end cap 52 and the second end cap 54 therefore securely, but rotatably, hold the transmissive roller 24 in place.

In embodiments of the invention, as illustrated in FIG. 6, the first end cap 52 includes the cable receptor 58. In some embodiments, as discussed above, at least one cable 36 is provided to the laser welding assembly 12, such as power, fiber optics, and/or communications cables. In embodiments of the invention in which the transmissive roller 24 presents the void 46 discussed above, at least one of the cables 36 enters the void 46 through the cable receptor 58. The cable receptor 58 is an opening or void in the first end cap 52.

In embodiments of the invention, as illustrated in FIG. 6, the second end cap 54 includes the motor mount 62 for securely holding the roller motor 60. The motor mount 62, as illustrated in FIG. 6, may be an opening into which the roller motor 60 is secured. The motor mount 62 securely holds the roller motor 60 in place, such that the roller motor 60 can engage with and rotate the transmissive roller 24.

The computing element 20 instructs actuation of the roller motor 60 to in turn drive the transmissive roller 24. The computing element 20 sends information indicative of instructions to power the roller motor 60. The roller motor 60 receives and interprets the command. The roller motor 60 includes an internal processing element and an internal communications element (not illustrated) to interpret the commands from the computing element 20. In other embodiments, the computing element 20 selectively provides power to the roller motor 60 to engage the roller motor 60 in lieu of providing instructions.

The roller motor 60 rotates the transmissive roller 24 by rotating a motor-interfacing segment 64 of the transmissive roller 24. In some embodiments of the invention, as illustrated in FIG. 6, the roller motor 60 rotates the motor-interfacing segment 64 via a rotating sprocket 66. The motor-interfacing segment 64 has a complementary shape to the sprocket 66 of the roller motor 60. As such, a rotation of the sprocket 66 by the roller motor 60 is translated to a rotation of the transmissive roller via the roller-interfacing segment.

The motor-interfacing segment 64 translates the power generated by the roller motor 60 to turn the transmissive roller. As shown in FIG. 6, the motor-interfacing segment 64 may comprise at least one sprocket to complementally interface with the sprocket 66 of the motor. In other embodiments, not illustrated, the motor-interfacing segment 64 may be an inward-facing sprocket that complementally interfaces with the sprocket 66 of the roller motor 60. In yet other embodiments, the motor-interfacing segment 64 is a single outward-facing sprocket that fits into a smaller sprocket 66 of the roller motor 60 that is offset from, but parallel to, the rotational axis of the transmissive roller 24. In yet further embodiments, there is no roller motor to power the transmissive roller 24. The transmissive roller 24 of these embodiments is therefore free rolling. The transmissive roller 24 rotates as a by-product of being pushed along the material sheet 18, as discussed below.

In embodiments of the invention, the heating element provides thermal energy to heat the transmissive roller 24. The heat generated by the heating element warms the material sheet 18 prior to and during the laser emission. Heating the material sheet 18 prior to welding reduces the amount of energy imparted by the welding laser 32. Heating the material sheet 18 prior to welding also reduces the change in temperature at the location of the weld, which reduces the expansion and/or shrinkage of the material. In embodiments that use at least one guide roller 30 to position the material sheet 18 onto the transmissive roller 24 before laying it flat upon the top layer of the material sheet 18, the heat is in contact with the material sheet 18 for a longer period of time.

The heating element converts electricity into heat through a process of resistive heating. An electrical current from a power source travels through the heating element and encounters electrical resistance, which generates heat. The heating element of this embodiment is an electrical wire that is secured adjacent to the transmissive roller 24. In other embodiments, the heating element is formed of a ceramic. In yet other embodiments, the heating element radiates the heat to the transmissive roller 24.

In other embodiments, different types of heating elements produce the heat that brings the material sheet 18 up to a desired temperature. In one embodiment, the entire environment around the controlled-bonding manufacturing system 10 is raised to the desired temperature. For example, the controlled-bonding manufacturing system 10 may be placed within an oven that is heated to a certain temperature so that all portions of the material sheet are uniformly heated prior to welding. In other embodiments, the heating element is located at the feeding element 16 to warm the material sheet 18 before it is fed into the laser welding assembly 12 and/or the flat base 14. For example, the material sheet 18 may be stored in a heated oven prior to the welding process and removed from the oven to be added to the controlled-bonding manufacturing system 10 via the feeding element 16.

Proper welds are achieved through controlling the thermal properties at the point of the weld. The thermal properties at the point of the weld are affected by the temperature of the transmissive roller 24, the temperature of the material sheet 18, the temperature of the lower layers of the material sheet 18, the amount of energy added by the welding laser 32, the dissipation rate of the heat from completed welds, the dissipation rate of ablated particles, the melting point of the material sheet 18, the temperature of the ambient air, etc. The controlled-bonding manufacturing system 10 may further comprise fans or ductwork for cooling the ambient air and/or the transmissive roller 24.

Following the completion of the welding and ablation for that layer of the material sheet, the object 38 is allowed to cool. In some embodiments, the system 10 may ablate material to create cooling channels. The portion of the material sheet 18 that is not going to be part of the completed object 38 is normally ablated to separate the object 38 from the rest of the material sheet 18. The cooling channels may be formed by additional ablation, beyond what is necessary to separate the object 38 from the remaining material sheet 18. The cooling channels allow a fluid, such as air or water, to reach the object 38 and cool the object 38 without affecting the integrity of the structure of the object 38. The cooling channels radiate away from the object 38 being created. The cooling channels may have a length that increases as each layer of the material sheet 18 is added, or may have a constant length. The cooling channels may have a depth as deep as the layers of the material sheet 18. In some embodiments, as discussed above in which the flat base 14 is filled with a liquid, the liquid flows through the cooling channels to cool the object 38.

The welding laser 32 will now be discussed. The welding laser 32 provides a large amount of energy to weld at least two layers of the material sheet 18 together. In some embodiments, more than two layers of the material sheet 18 are welded simultaneously. This continues to reinforce the bonds formed by re-welding them upon the application of a new layer of the material sheet 18.

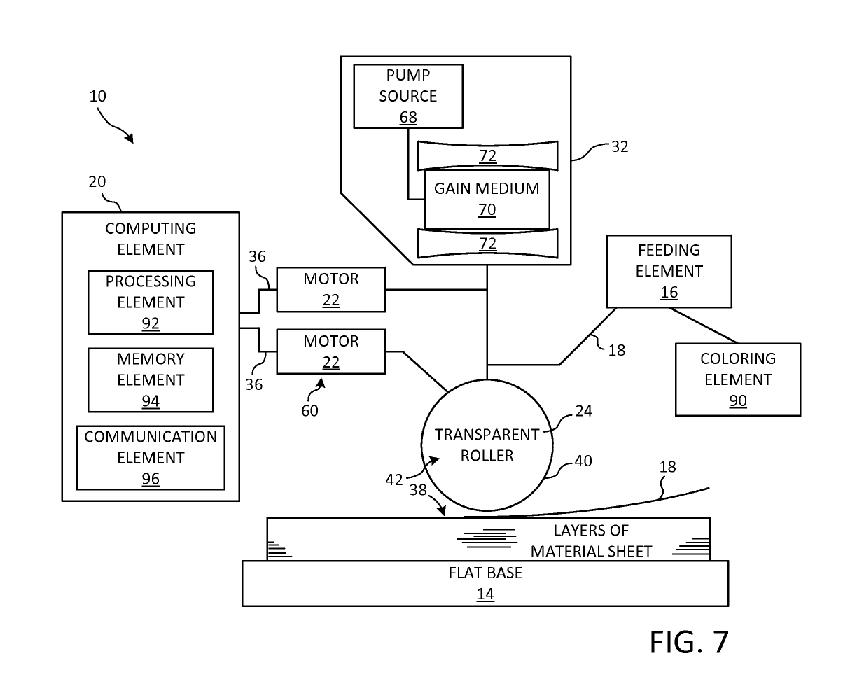

The welding laser 32, as schematically illustrated in FIG. 7, is comprised of a pump source 68, a gain medium 70, and an optical resonator 72. The pump source 68 is the power supply that provides the energy for the laser beam. Energy from the pump source 68 excites the gain medium 70 to produce an emission of photons. The gain medium 70 concentrates the photons. The gain medium 70 also determines the laser beam's frequency. The optical resonator 72 comprises a highly reflective mirror and a partially reflective mirror. The optical resonator 72 allows the laser beam to pass through the partially reflective mirror, such that it is a highly concentrated beam of energy. Some embodiments of the welding laser 32 comprise a plurality of gain mediums 80 and optical resonators 72. For example, there may be four sets of gain mediums 80 and optical resonators 72, each of which produces 10 W of energy. The combined energy of the welding laser 32 would in this case be 40 W of energy.

The laser beam is emitted through the circular wall 48 of transmissive roller 24 onto the material sheet 18. The laser beam provides a rapid acceleration of temperature to the immediate area contacted by the laser beam. The portion of the material sheet 18 contacted by the laser beam welds to at least the next-lower layer of the material sheet 18, as discussed below. In other embodiments in which the transmissive roller 24 is solid, the laser beam is emitted through the entire transmissive roller 24.

In some embodiments, a fiber optic cable 74 transmits the laser beam from the welding laser 32 and emits the laser beam through the transmissive roller 24 onto the material sheet 18. At least one welding laser 32 may be culminated using at least one optical lens 76 into a single non-coherent beam that is channeled into a single fiber optic cable 74 having a relatively large core. Multiple laser beams from multiple welding lasers 32 are culminated together into the fiber optic cable 74 may decrease the costs of the system 10 and increase the useful life of the welding laser 32. This is because the welding laser 32 remains stationary and does not move with the welder housing 26. The welding laser 32 therefore does not have to be compact, and it does not receive the wear from being moved across the material sheet 18.

In some embodiments of the invention, at least one optical lens 76 is secured adjacent to the end of the fiber optic cable 74. As the laser beam emerges from the fiber optic cable 74, the at least one lens 76 focuses the laser beam to increase the intensity. As shown in FIG. 6, two successive lenses 76 may be used, each of which successively focuses the laser beam. The lens 76 is formed of glass or a substantially transparent polymer. The lens is generally disc shaped and may be convex or concave.

In some embodiments, the welding laser 32 may comprise a mirror 78, as illustrated in FIGS. 4 and 6. The laser beam is emitted onto the mirror 78 and reflected toward a portion of the transmissive roller 24. As shown in FIG. 6, the laser beam comes in parallel to the manufacturing plane. The mirror 78 reflects the laser beam in a different direction away from parallel with the manufacturing plane. The reflected laser beam is in a plane perpendicular, but not necessarily normal to, the manufacturing plane.

A pivoting mirror mount 80 changes the angle of reflection of the mirror 78 in a rastering motion. The computing element 20 sends instructions that are interpreted by the pivoting mirror mount 80. The computing element 20 selectively instructs the pivoting mirror mount 80 to rotate or pivot to a specific angle, based upon the location of the desired weld. The pivoting mirror mount 80 is adapted to pivot or rotate rapidly. For example, the pivoting mirror may achieve at least 10 angles per second, at least 50 angles per second, at least one hundred angles per second, or at least one thousand angles per second. Similarly, the welding laser 32 is adapted to emit the laser beam in pulses associated with the rapid pivoting of the pivoting mirror mount 80.

In one embodiment, the pivoting mirror mount 80 changes the angle of reflection of the mirror 78 to reflect the laser beam in an upward direction. This laser beam ablates the material sheet 18 to prevent additional material sheet from being applied. This may be performed as the laser welding assembly 12 nears or reaches the end of a current welding path so that the laser welding assembly 12 may move relative to the flat base 14 without a material sheet 18 being added. For example, it may also allow the separation between the transmissive roller 24 and the lower layers of the material sheet 18 for ablation, as discussed below. As another example, the laser welding assembly 12 may then pivot to travel in a different direction or return to a starting location to begin the next layer of the material sheet 18.

The welding laser 32, via the mirror 78 and pivoting mirror mount 80, can emit the laser beam at any point along the body 44 of the transmissive roller 24. The welding laser 32 pulses the laser beam in combination with the movement of the pivoting mirror mount 80 to rapidly achieve numerous welds as the transmissive roller 24 moves rolls along the top layer of the material sheet 18. The computing element 20 instructs the welding laser 32 to weld at intervals. For example, the computing element 20 may instruct the welding laser 32 to pulse fifty to one hundred thousand times per second, ten to ten thousand times per second, or one to one thousand times per second. The pulsing of the welding laser 32 combined with the pivoting of the mirror 78 produces a weld along the surface of the material sheet 18 once every 0.5-1 mm, once every 1-2 mm, once every 2-4 mm, or once every 4-10 mm. The desired distance between welds may be determined by the speed of manufacturing, the desired bond strength (as discussed below), the material that forms the material sheet 18, and/or the thickness of the material sheet 18. It should be noted that the material in the interval is neither welded nor ablated but remains a part of the complete object 38. In some embodiments, the welding laser 32 emits a laser beam that is continuous instead of at intervals.

In other embodiments, the welding laser 32 utilizes a synergistic stimulation other than photons, such as electrons or plasma. In the case of electrons, free electrons in a vacuum are manipulated by electric and/or magnetic fields so that they form a beam. The electron beam is transmitted through the transmissive roller 24 and impacts the top layer of the material sheet 18. The kinetic energy of the electrons is converted into heat, which welds the top layer of the material sheet 18 to at least one lower layer of the material sheet 18. In the case of plasma, a high-energy ionized gas is manipulated to form a beam. The kinetic energy of the plasma is converted into heat, which welds the top layer of the material sheet 18 to at least one lower layer of the material sheet 18.

In some embodiments, a plurality of layers of the material sheet 18 are welded simultaneously. To transmit the energy from the laser beam to the lower layers of the material sheet 18, the material sheet 18 may be formed of an at least partially transparent or translucent material. As the laser beam contacts the top layer of the material sheet 18, a portion of the light of the laser beam is transmitted through the top layer of the material and to the next-lower layer of material. It is to be appreciated that some materials will absorb some of the light; however, the transmissive property of the material allows for at least 25%, at least 50%, at least 75%, at least 90%, or at least 95% of the laser's light to transmit through the top layer of the material. As such, in some embodiments up to 4, up to 7, or up to 10 layers of the material sheet may be welded simultaneously. Moreover, in embodiments of the invention, the material need no be transparent or translucent. In such embodiments, the material is not opaque; that is, the material allows for some light transmission. However, such embodiments allow for the material to also have some light absorption. In such embodiments, the material may allow for at least 50%, at least 60%, at least 70%, at least 80%, or at least 90% of light transmission through the non-opaque and non-translucent/transparent material.

In some embodiments, the controlled-bonding manufacturing system 10 selectively creates a relatively strong bond in a segment of the object 38 and a relatively weak bond in another segment of the object 38. This may be advantageous in some applications for several reasons including, but not limited to, designing where the object 38 will break for safety reasons, designing a portion of the object 38 to act as support material, designing an object 38 that comprises multiple parts to easily break apart for assembly by a user, designing a bond to break, etc. The user may enter desired bond strengths into the computing element 20, discussed below. The computing element 20 then interprets the desired bond strengths and adjusts the welding process to achieve the different bond strength. The adjustments may include adjusting the frequency, intensity, or number of the laser beams; adjusting the temperature of the transmissive roller 24; adjusting the speed of the transmissive roller 24; adjusting the interval between welds; etc. For example, to achieve weaker bond strength in a portion of the object 38, the computing element 20 sends instructions for the welding laser to emit a laser beam of a lower intensity at a portion of the object material sheet 18. As another example, the computing element may instruct the welding laser to weld once every 4 mm instead of once every 2 mm. As yet another example, the computing element 20 may instruct the welding laser 32 to ablate a plurality of voids into the object 38 in a location where a weaker bond is desired. As the plurality of voids is filled over by additional layers of the material sheet, the plurality of voids leaves a segment weaker than the surrounding segments.

Ablation is the vaporization of material from the material sheet 18. Ablation removes material from portions of the material sheet 18 that will not be in the completed object 38. On a first pass, the welding laser 32 welds the material sheet to the next lower layer of the material sheet. On a second pass, the laser welding assembly 12 passes over the same location without providing a new layer of the material sheet 18 and without being in contact with the top layer of the material sheet 18. As the laser beam is emitted into the top layer of the material sheet 18, air is present. The presence of air allows the material sheet to ablate instead of welding to the next lower layer of the material sheet. The ablated material is emitted into the air and may be captured as discussed below.

In some embodiments, the welding laser 32 ablates by sending a higher-intensity beam. In other embodiments, an ablation laser (not illustrated), which is separate from the welding laser 32, ablates by sending a laser beam. The ablation laser may utilize the same mirror 78 and pivoting mirror mount 80, a secondary mirror and secondary pivoting mirror mount (not illustrated), or it may transmit directly through the transmissive roller 24. In another embodiment, the ablation laser is incident directly onto the material sheet 18 but does not transmit through the transmissive roller 24. The ablation laser may be secured to the welder housing 26, or it may be secured to another housing.

In some embodiments, ablation of excess material is performed at a time after the welding of the material sheet 18. The welding laser 32 may make a first pass to weld the material sheet 18 to a lower layer of the material sheet 18. The ablating laser would at a later time travel over the same location and ablate away the undesired locations that were not previously welded. The later time could be 0.1-1 seconds later, 1-2 seconds later, or 2-5 seconds later.

The ablated particles from the material sheet 18 are expelled into the ambient air. In some embodiments, the ablated particles are collected and disposed of in a porous material, such as a sponge or foam. The porous material may be secured to the welder housing 26, to a side or top section of the flat base 14, or otherwise in the surrounding environment. The ablated particles can then, at a later time, be removed from the porous material and disposed of or recycled.

The excess material sheet, i.e., those portions of the material sheet 18 that are neither welded as part of the object 38 nor ablated, may be removed during or after the manufacturing process. In some embodiments, the excess material sheet is at least partially welded to the next lower layer of the material sheet 18 as to keep the top layer of material sheet 18 generally flat. This facilitates the welding of subsequent layers of the material sheet 18 because subsequent layers of the material sheet are laid upon a layer of the generally flat top, as illustrated in FIG. 7. In other embodiments, the excess material sheet is removed during the manufacturing process.

In some embodiments of the invention, at least one optical sensor 34 is secured to the welder housing 26 and adapted to observe physical properties of various aspects of the object manufacturing process. The optical sensor 34 then provides information to the computing element 20. The computing element 20 interprets the information received from the optical sensor 34 and performs calculations to ensure proper construction of the object 38.

The optical sensor 34 may be a set of photo-diodes, a camera, infrared detector, light detector, or a combination thereof. Optical sensors that are a set of photo-diodes may be arranged linearly to measure the width of the material sheet 18. Two sets of photo-diodes may be used, each aligned to measure a respective side. In some embodiments, the controlled-bonding manufacturing system 10 will lay a layer of material sheet 18 next to another layer of the material sheet 18. Because the material sheet 18 is produced within a manufacturing tolerance for width, slight variations in width may be present in the material sheet 18. Therefore, the photo-diodes precisely measure the width of the material sheet 18 as it is being applied to the next-lower layer. On a subsequent pass, the computing element 20 will instruct the laser welding assembly 12 precisely where to begin laying another layer of the material sheet 18 such that it is laid adjacent to the other layer without any substantial gaps or overlapping portions. Gaps and overlapping portions of the material sheet 18 would weaken the created bonds undesirably.

Optical sensors that are cameras may be oriented generally downward to observe the construction of the object 38. The optical sensor 34 that is a camera may send live feed video to the computing element 20. The optical sensor 34 that is a camera may in addition or in the alternative send periodic photographs. Optical sensors that are infrared detectors measure the heat that is present at various locations on the controlled-bonding manufacturing system 10. The heat may be measured at the point that is being welded, the material sheet 18 prior to being welded, the lower layers of material sheet 18 before being covered by the material sheet 18, the transmissive roller 24, or a combination thereof. The computing element 20 interprets this heat information to determine if an increase or decrease in temperature would be advantageous. Optical sensors that are light detectors measure the amount of light at a specific location. The optical sensor 34 that is a light detector may detect the intensity of the laser beam that is contacting the material sheet 18 and/or the transmissive roller 24.

The computing element 20, discussed below, interprets the information collected and transmitted by the at least one optical sensor 34. The computing element 20 may then, based upon the calculated interpretations, adjust various conditions of the object manufacturing, including, but not limited to, increasing or decreasing the intensity of the welding laser 32, increasing or decreasing the heat generated by the heating element, increasing or decreasing the mechanical pressure placed on the material sheet 18, increasing or decreasing the speed that the transmissive roller 24 moves over the material sheet 18, etc.

In embodiments of the invention, at least one cable 36 attaches to the welder housing 26. The at least one cable 36 may comprise, for example, power cables, data transmission cables, and fiber optic cables. The at least one cable 36 interfaces with at least one component of the laser welding assembly 12. In some embodiments, each of the at least one cable 36 interfaces with an exterior connection segment (not illustrated). In other embodiments, each of the at least one cable 36 interfaces with the respective component to which it provides power, communications, etc. In these embodiments, the at least one of the cables 36 will enter into the laser welding assembly 12 via the cable interface, discussed above. By way of example, the heating element may receive power from an external power source via a power cable, the roller motor 60 may receive commands from the computing element 20 via a communications cable, and the laser beam may be transmitted to the lens via the fiber optic cable 74 (discussed above).

In addition, or in the alternative, communications among the various components of the controlled-bonding manufacturing system 10 may be via wireless communications. In addition, or in the alternative, powering of the various components of the controlled-bonding manufacturing system 10 may be by battery. Using a battery to power components may be advantageous because it eliminates one cable. However, using a battery may also be disadvantageous because batteries lose power over time and require periodic replacement.

The movement of the laser welding assembly 12 is controlled by the computing element 20, discussed below. The computing element 20 provides information indicative of commands to at least one motor 22 that moves the laser welding assembly 12. In embodiments of the invention, the information indicative of commands comprises information indicative of a certain location on the material sheet 18 to ablate, a certain location on the material sheet 18 to weld, a desired bond strength for the weld, etc.

In embodiments of the invention, the laser welding assembly 12 moves along the material sheet 18 atop the flat base 14 by moving along at least one track. In one embodiment of the invention, the laser welding assembly 12 moves along a set of inner tracks 82. The laser welding assembly 12, in combination with the set of inner tracks 82, moves along a set of outer tracks 84.

The set of inner tracks 82, as illustrated in FIG. 6, is oriented parallel to the body 44 of the transmissive roller 24. The track-interfacing segment 56 of the first end cap 52 and the second end cap 54 surrounds or otherwise interfaces with the set of inner tracks 82. The track-interfacing segment 56 of the first end cap 52 and the track-interfacing segment 56 of the second end cap 54 ensure that the laser welding assembly 12 remains substantially parallel to the set of inner tracks 82.

The set of outer tracks 84, as illustrated in FIG. 1, is oriented perpendicular to the set of inner tracks 82. The set of outer tracks 84 is also, therefore, perpendicular to the laser welding assembly 12. The set of inner tracks 82 and the set of outer tracks 84 are either substantially in the same plane, or substantially in parallel planes, parallel with the manufacturing plane. The set of outer tracks 84 is stationary. The set of inner tracks 82 moves relative to the set of outer tracks 84. The combination of the set of inner tracks 82 and the set of outer tracks 84 therefore allows the laser welding assembly 12 to be located at any point on the flat base 14.

The set of outer tracks 84 is secured above the flat base 14. As discussed above, in embodiments of the invention, the flat base 14 lowers incrementally with the addition of each layer of the material sheet 18. Because the set out outer tracks 84 is stationary, the lowering of the flat base 14 allows the material sheet 18 to be placed, while still providing pressure to assist in the welding process.

An outer-track motor 86 moves the set of inner tracks 82 relative to the set of outer tracks 84. An inner-track motor 88 moves the laser welding assembly 12 relative to the set of inner tracks 82. The outer-track motor 86 is securely coupled to either or both ends of the set of inner tracks 82. The computing element 20 sends instructions to the outer-track motor 86 to move the set of inner tracks 82 to a certain location. The computing element 20 sends instructions to the inner-track motor 88 to move the laser welding assembly 12 to a certain location. Through the movement of the outer-track motor 86 and the inner track motor 88, the laser welding assembly 12 is adapted to reach each location on the flat base 14.

In another embodiment, not illustrated, the transmissive roller 24 is perpendicular to the set of inner tracks 82 and parallel to the set of outer tracks 84. In yet another embodiment, the laser welding assembly 12 moves along a single inner track, not illustrated. In a yet further embodiment, a set of perpendicular tracks each move relative to an outer frame, not illustrated. In still further embodiments, a combination of the above-mentioned track configurations is used to allow the laser welding assembly 12 to be in any given position.

In some embodiments, an articulating robotic arm (not illustrated) moves the laser welding assembly 12 across the flat base 14. The robotic arm controls the movement of the laser welding assembly 12 in all directions. The robotic arm may also place a pressure on the material sheet 18 to aid in the welding process.

In some embodiments of the invention, the laser welding assembly 12 is adapted to rotate along an axis perpendicular to the manufacturing plane of the flat base 14. The laser welding assembly 12 can therefore operate in a plurality of directions, each substantially parallel with the manufacturing plane of the flat base 14. This allows for cross-welding. For example, the laser welding assembly 12 welds the material sheet 18 to a lower layer of the material sheet 18 with the transmissive roller 24 traveling in a first direction. Then, the laser welding assembly 12 welds the next layer of the material sheet 18 by rolling the transmissive roller 24 from a direction perpendicular (but in the same plane) as the first direction. This may produce stronger bonds and provide other benefits.

The provision of the material sheet 18 to the laser welding assembly 12 for the creation of the object 38 will now be discussed. The feeding element 16 of the controlled-bonding manufacturing system 10 provides the material sheet 18 to the laser welding assembly 12. The feeding element 16 is a passive component, such as a rotatable cylinder upon which the material sheet 18 is stored. The material sheet 18 may be a single, continuous sheet of material that is wound around a center core to provide a roll of material. As the transmissive roller 24 moves along the lower layers of the material sheet 18, the feeding element 16 rolls. The rolling of the feeding element 16 provides the material sheet 18 to the laser welding assembly 12.

The at least one guide roller 30 of the laser welding assembly 12 receives the material sheet 18 from the feeding element 16. Each of the at least one guide rollers 30 is rotatably secured to the welder housing 26. In one embodiment of the invention, as illustrated in FIG. 6, there are four guide rollers 30 on the laser welding assembly 12. The material sheet 18 travels from the feeding element 16 to the area between the two top guide rollers 30. The material sheet 18 then moves down to contact the transmissive roller 24. As discussed above the transmissive roller 24 is, in embodiments, coated with silicone that adheres to the material sheet 18 via contact pressure. The material sheet 18 then travels along the transmissive roller 24 (dependent on the direction in which the transmissive roller 24 rotates). The material sheet 18 continues to travel along the rotating transmissive roller 24 until it reaches a position directly below the welding laser 32. The welding laser 32 then selectively welds and/or ablates the material sheet 18. The material sheet 18 then dissociates with the transmissive roller 24 and remains either welded to the lower layer of the material sheet 18, adjacent to the material sheet 18, or is ablated and dissipates into the air or liquid.

In some embodiments, the guide rollers 30 are passive. In other embodiments, the guide rollers 30 comprise at least one guide motor for pulling the material sheet 18 from the feeding element 16.

The material sheet 18 travels from the feeding element 16 to the guide rollers 30 in a substantially straight line. To achieve this, the feeding element is secured to the laser welding assembly 12. This allows the laser welding assembly 12 to move laterally across the flat base 14 and still ensure that the material sheet 18 is fed straight into the guide rollers 30. In other embodiments of the invention, the feeding element 16 moves laterally in a direction parallel to the direction of orientation of the transmissive roller 24. As the laser welding assembly 12 moves along the set of interior tracks, the feeding element 16 copies the lateral movement. The copying of the lateral movement may either be active via commands from the computing element 20, or passively by being pulled by the lateral movement of the laser welding assembly 12.

In other embodiments of the invention, the feeding element 16 is a powered, active component that supplies the material sheet 18. The feeding element 16 may be a conveyor belt. After the controlled-bonding manufacturing system 10 welds a first set of bonds and ablates away the unwanted material, the conveyor belt moves the rest of the material sheet 18 (that was not ablated or welded) until the entire object 38 is covered by an uninterrupted portion of the material sheet 18. The laser welding assembly 12 then continues to weld and ablate in this new portion. The conveyor belt may also rise or fall to keep the material sheet 18 flat atop the object 38 being created.

The feeding element 16 that is a conveyor belt, not illustrated, has a material roll and an excess roll. At a beginning of the object-forming process, the material sheet 18 is wound in a continuous roll, as noted above. During the manufacturing process, the material sheet 18 unrolls from the material roll and rolls into the excess roll. This process continues until the object 38 is fully created or the material roll has dispensed the entire material sheet 18. The excess roll may then be melted down and reformed into a new material sheet.

In another embodiment in which the feeding element 16 is a powered, active component, the feeding element 16 places a new material sheet 18 atop the layers upon the completion of the welding and ablating for that layer of the material sheet 18. The material sheet 18 of this embodiment is therefore a plurality of sheets, each of which is fed atop the other upon the completion of the welding and ablating of the prior sheet. As discussed above, the flat base 14 may move down incrementally so that each material sheet 18 is added to the top of the layers of the material sheet 18. In other embodiments, the feeding element 16 and the laser welding assembly 12 move up incrementally with each material sheet 18 being added.

In some embodiments of the invention, the feeding element 16 feeds the material sheet 18 from multiple directions. In one embodiment, there is a plurality of feeding elements 16, each of which feeds a separate material sheet from a separate direction. In another embodiment, the feeding element 16 rotates so as to feed the material sheet 18 from a plurality of directions. Feeding sheets from multiple directions may increase the bond strength by altering how the molecules of the material sheet 18 align between layers.

In some embodiments of the invention, the controlled-bonding manufacturing system 10 comprises a coloring element 90. The coloring element 90 is adapted to add or change the color of the material sheet 18 prior to the welding process. The coloring element 90 may spray an ink or other coloring solution onto the material sheet 18 before the feeding element 16 moves the material sheet 18 to be welded. Depending on the application, the added color may be allowed to dry prior to the welding process.

The coloring element 90 creates colored objects (not illustrated). Colored objects may be desirable for many reasons. Colored objects are aesthetically pleasing. Colored objects may also contain writing, marks, or other indicia. Colored objects may also be a certain color for easy identification and differentiation from other objects.

Coloring the material sheet 18 before it is assembled into the object may also be desirable. The complex surfaces of certain objects make uniform coloring difficult or impossible. Coloring the material sheet 18 before it is assembled also produces durable coloring. While external coloring can wear or chip away, the coloring element 90 creates objects that are uniformly colored beneath the surface.

The coloring element 90 may also create alignment marks on the object 38 or the material sheet 18. For example, the coloring element 90 may create an alignment mark every centimeter along the material sheet 18. The optical sensor 34 is adapted to detect these alignment marks. As the controlled-bonding manufacturing system 10 creates the object 38, the computing element 20 analyzes the detected alignment marks to ensure that the object 38 is being created correctly.

The computing and communicating of the controlled-bonding manufacturing system 10 will now be discussed. The computing element 20 controls the other components of the controlled-bonding manufacturing system 10. Typically, the user inputs a desired 3D shape into the computing element 20 via a graphical user interface (GUI). In addition to the input 3D shape, embodiments of the invention allow the user to specify bond strengths at any or all locations of the object 38. The user can select specific areas to receive weaker bonds or stronger bonds. The user may also be able to specify a density for at least a portion of the object 38. In some embodiments, the user can also select a color or colors for the object 38. In some embodiments, the user can also select at least a portion of the object 38 to be created via cross-welding, discussed above. The computing element 20 then autonomously or semi-autonomously creates the objects 38 as described by the input 3D shape and other requirements.

The computing element 20 comprises at least one processing element 92, at least one memory element 94, and at least one communications element 96. The processing element 92 calculates, based upon the input 3D shape, the precise locations in which the material sheet 18 is to be welded and ablated for each layer of the material sheet 18. The memory element 94 stores the information indicative of the precise locations. The communications element 94 of the computing element 20 sends information indicative of actions that the controlled-bonding manufacturing system 10 shall take to create the object 38. The computer either controls the various components directly or indirectly. For example, to move the laser welding assembly 12, the computing element 20 may selectively provide power to a motor 22 instead of sending a command for the laser welding assembly 12 to move. Alternatively, to fire the welding laser 32 at a given location, the computing element 20 may send an instruction that is interpreted by the welding laser 32.

The controlled-bonding manufacturing system 10 may comprise additional computing elements, servers, database, and communications networks to facilitate the functions and features described herein. The computing elements 20 and servers may comprise any number and combination of processors, controllers, integrated circuits, programmable logic devices, or other data and signal processing devices for carrying out the functions described herein, and may additionally comprise one or more memory storage devices, transmitters, receivers, and/or communication busses for communicating with the various devices of the system 10. In various embodiments of the invention, the computing devices may comprise the processing element 92, the memory element 94, the communication element, a display, the GUI, and a printer. In various embodiments of the invention, any or all of these components may be located on the laser welding assembly 12, on a stationary computing element 20 associated with the controlled-bonding manufacturing system 10, or on a server.

In embodiments of the invention, the computing devices and/or databases may implement the computer program and/or code segments of the computer program to perform some of the functions described herein. The computer program may comprise a listing of executable instructions for implementing logical functions in the user device. The computer program may be embodied in any computer readable medium for use by or in connection with an instruction execution system, apparatus, or device, and execute the instructions. In the context of this application, a “computer readable medium” may be any means that may contain, store, communicate, propagate, or transport the program for use by or in connection with the instruction execution system, apparatus, or device. The computer readable medium may be, for example, but not limited to, an electronic, magnetic, optical, electro magnetic, infrared, or semi conductor system, apparatus, device or propagation medium. More specific, although not inclusive, examples of the computer readable medium would include the following: a portable computer diskette, a random access memory (RAM), a read only memory (ROM), an erasable, programmable, read only memory (EPROM or flash memory), and a portable compact disk read only memory (CDROM), and combinations thereof. The various actions and calculations described herein as being performed by or using the computer program may actually be performed by one or more computers, processors, or other computational devices, such as the exemplary device described herein, independently or cooperatively executing portions of the computer program.

The computing devices may specifically include mobile communication devices (including wireless devices), work stations, desktop computers, laptop computers, palmtop computers, tablet computers, portable digital assistants (PDA), smart phones, and the like, or combinations thereof. Various embodiments of the computing device may also include voice communication devices, such as cell phones and/or smart phones. In some embodiments, the computing device will have an electronic display operable to display visual graphics, images, text, etc. In certain embodiments, the computer program facilitates interaction and communication through the GUI that is displayed via the electronic display. The GUI enables the user to interact with the electronic display by touching or pointing at display areas to provide information to the system 10.

The communication network may be wired or wireless and may include servers, routers, switches, wireless receivers and transmitters, and the like, as well as electrically conductive cables or optical cables. The communication network may also include local, metro, or wide area networks, as well as the Internet, or other cloud networks. Furthermore, the communication network may include cellular or mobile phone networks, as well as landline phone networks, public switched telephone networks, fiber optic networks, or the like.

The computer program may run on computing devices or, alternatively, may run on one or more server devices. In certain embodiments of the invention, the computer program may be embodied in a stand-alone computer program (i.e., an “app”) downloaded on a user's computing device or in a web-accessible program that is accessible by the user's computing device via the communication network. As used herein, the stand-alone computer program or web-accessible program provides users with access to an electronic resource from which the users can interact with various embodiments of the invention.

A few alternative embodiments of the invention will now be discussed. In some embodiments, granular particles are used in addition to, or instead of, the material sheet 18. The granular particles are placed atop the flat base 14 (which may further comprise side walls in this embodiment). The transmissive roller 24 then presses down on the granular particles and selectively welds them and/or ablates them with the welding laser 32. The non-stick properties of the transmissive roller 24 prevent the granular particles from adhering to the transmissive roller 24. The pressure from the transmissive roller 24 creates relatively dense objects 38.

In some embodiments of the invention, the controlled-bonding manufacturing system 10 can be utilized in a stereolithography additive manufacturing system. A stereolithography additive manufacturing system employs a vat of liquid resin that is curable utilizing an ultraviolet laser beam. The transmissive roller 24 of the laser welding assembly 12, as described herein, could be utilized to provide mechanical pressure to increase the bond strengths of the objects created via stereolithography.

In some embodiments, the flat base 14 is filled with water or another liquid. In one embodiment, the welding process takes place slightly above the surface of the liquid. As the object 38 is slowly lowered into the water by the flat base 14, the liquid assists in quickly cooling the object 38.

In another embodiment, the welding process takes place slightly below the water surface. The pressure of the transmissive roller 24 pressing down on the layers of the material sheet 18 squeezes out the liquid from directly under the transmissive roller 24. This allows the laser welding assembly 12 to weld the specific sections of the material sheet 18 directly under the transmissive roller 24 while keeping all other areas of the object 38 submerged in the liquid for temperature control. This also prevents the ablated material from dissipating into the ambient air by quickly submerging the ablated area in a liquid. The ablated particles are then suspended in the liquid or sink to the bottom of the flat base 14.

Various methods associated with the controlled-bonding manufacturing system 10 will now be discussed. The methods include, but are not limited to, a method of manufacturing using the controlled-bonding manufacturing system 10, a method of assembling the controlled-bonding manufacturing system 10, and a method of using the controlled-bonding manufacturing system. It should be noted that the sequence of steps discussed is only exemplary and not intended to limit the invention.

A method of manufacturing using the controlled-bonding manufacturing system 10 comprises the steps of: providing at least one lower layer of the material sheet 18 atop the flat base 14; providing another layer of the material sheet 18 from a feeding element 16; compressing the layers of the material sheet 18 via a mechanical pressure from the transmissive roller 24 such that substantially all of the air is removed; emitting a laser beam through at least a portion of the transmissive roller 24 sufficient to weld at least two layers of the material sheet 18; emitting a laser beam to ablate at least a portion of the layers of the material sheet 18; and repeating the process for each successive layer of the material sheet.

A method of assembling the controlled-bonding manufacturing system 10 comprises the steps of emplacing the set of inner tracks 82 through the track-interfacing segments 56 of the first end cap 52 and the second end cap 54; emplacing the roller motor 60 in the second end cap 54; inserting the sprocket 66 of the roller motor 60 into the motor-interfacing segment 64 of the transmissive roller 24; inserting and installing the welding laser 32 into the void 46 of the transmissive roller 24; emplacing the at least one cable 36 through the cable receptor 58 of the first end cap 52; securing the traversing segment 50 of the welder housing 26 to the first end cap 52; sliding the transmissive roller 24 into the traversing segment 50; rotatably securing the transmissive roller 24 to both the first end cap 52 and the second end cap 54; securing the guide rollers 30 to the welder housing 26; securing the set of inner tracks 82 to the outer-track motor 86; and securing power cables and communication cables 36.

A method of using the controlled-bonding manufacturing comprises the steps of accessing the computing element 20; inputting the desired 3D shape; inputting other requirements for the object 38, such as color and bond strength; supplying the feeding element 16 with the material sheet 18; instructing the computing element 20 to manufacture the object 38; removing the completed object 38; removing the excess material sheet 18 after completion; and recycling or disposing of the excess material sheet 18.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A controlled-bonding manufacturing system for creating an object from at least one material sheet, the system comprising:
a flat base adapted to receive a plurality of layers of the at least one material sheet layered thereon;
a laser welding assembly adapted to move relative to the flat base, including—
a welder housing;
a transmissive roller rotatably coupled to the welder housing,
wherein the transmissive roller is adapted to roll atop the plurality of layers of the material sheet located on the flat base,
wherein the transmissive roller places a mechanical pressure on the plurality of layers of the at least one material sheet as it rolls,
wherein the mechanical pressure forces out substantially all of the air between the transmissive roller and the plurality of layers of the at least one material sheet;
a welding laser adapted to emit a laser beam through at least a portion of the transmissive roller,
such that the absence of air, the mechanical pressure, and the emitted laser beam welds at least a portion of a top layer of the material sheet to at least one other layer of the material sheet;
a feeding element adapted to provide the material sheet to the laser welding assembly; and
a computing element to control the movement of the laser welding assembly and the emission of the laser by the welding laser.

2. The controlled-bonding manufacturing system of claim 1,
wherein the object has a first bond strength in a first segment and a second bond strength in a second segment,
wherein the first bond strength is different than the second bond strength,
wherein information indicative of the first bond strength and information indicative of the second bond strength were input into the computing element by a user.

3. The controlled-bonding manufacturing system of claim 1, wherein the object has a density that is at least 95 percent.

4. The controlled-bonding manufacturing system of claim 1, wherein the laser welding assembly further comprises at least one motor for rotating the transmissive roller.

5. The controlled-bonding manufacturing system of claim 1, wherein the mechanical pressure is generated by the relative positions of the transmissive roller, the layers of the material sheet, and the flat base.

6. The controlled-bonding manufacturing system of claim 1,
wherein the transmissive roller is hollow so at to present a void and a circular wall,
wherein at least a portion of the welding laser is disposed within the void of the transmissive roller,
wherein the welding laser is adapted to emit the laser beam through the circular wall of the transmissive roller.

7. The controlled-bonding manufacturing system of claim 1, further comprising at least one optical sensor,
wherein the optical sensor is adapted to capture data indicative of a width of the material sheet,
wherein the optical sensor transmits the captured data to the computing element for analysis.

8. The controlled-bonding manufacturing system of claim 1, wherein the flat base is incrementally lowered as the layers of material sheet are added to the flat base.

9. The controlled-bonding manufacturing system of claim 1, wherein the welder housing comprises:
a traversing segment oriented parallel to the orientation of the transmissive roller;
a first end cap adapted to rotatably couple to a first end of the transmissive roller; and
a second end cap adapted to rotatably couple to a second end of the transmissive roller.

10. The controlled-bonding manufacturing system of claim 1, further comprising:
at least one guide roller rotatably secured to the laser welding assembly,
wherein the feeding element provides the material sheet to the at least one guide roller,
wherein the at least one guide roller directs the material sheet onto the transmissive roller.

11. The controlled-bonding manufacturing system of claim 1,
wherein the transmissive roller is coated with a substance to prevent the transmissive roller from adhering to the top layer of the material sheet being welded,
wherein said substance coating the transmissive roller is selected from the group consisting of silicone, fluoropolymers, and teflon.

12. The controlled-bonding manufacturing system of claim 13,
wherein the welding laser emits a synergistic stimulation of particles,
wherein said synergistic stimulation of particles is selected from the group consisting of photons, electrons, and plasma.

13. The controlled-bonding manufacturing system of claim 1, further comprising:
a set of inner tracks movably secured to the laser welding assembly,
wherein the set of inner tracks is in a plane that is substantially parallel with the flat base;
a set of outer tracks perpendicular to the first set of tracks and in a plane substantially parallel with the plane of the first set of tracks; and
an outer-set motor movably connecting the set of outer tracks to the set of inner tracks, such that the set of outer tracks is stationary and the set of inner tracks moves along the first set of tracks.

14. The controlled-bonding manufacturing system of claim 15,
wherein the welder housing comprises at least one track-interfacing segment,
wherein the welder housing is movably secured to the set of inner tracks, such that the welder housing moves along the set of inner tracks.

15. A laser welding assembly for creating an object from at least one material sheet, the assembly comprising
a welder housing;
a substantially transmissive roller rotatably coupled to the welder housing,
wherein the transmissive roller is adapted to roll atop the plurality of material sheets located on the flat base,
wherein the transmissive roller places a mechanical pressure on the at least one material sheet as it rolls,
wherein the mechanical pressure forces out substantially all of the air between the transmissive roller and the plurality of layers of the at least one material sheet;
a welding laser adapted to emit a laser through at least a portion of the transmissive roller,
such that the absence of air, the mechanical pressure, and the emitted laser welds at least a portion of a top sheet of the plurality of material sheets to at least one other sheet of the plurality of material sheets; and
at least one guide roller adapted to receive the material sheet.

16. The laser welding assembly of claim 17, wherein the welder housing further comprises:
a traversing segment oriented parallel to the orientation of the transmissive roller;
a first end cap adapted to rotatably couple to one end of the transmissive roller;
a second end cap adapted to rotatably couple to a second end of the transmissive roller; and
at least one motor disposed in a motor mount on the second end cap,
wherein the at least one motor is adapted to rotate the transmissive roller.

17. The laser welding assembly of claim 17,
wherein the transmissive roller is hollow so at to present a void and a circular wall,
wherein at least a portion of the welding laser is disposed within the void of the transmissive roller,
wherein the laser beam of the welding laser is adapted to travel through the circular wall of the transmissive roller.

18. A method of manufacturing an object from at least one material sheet, the method comprising the following steps:
providing at least one lower layer of the material sheet atop a flat base;
providing an additional layer of the material sheet from a feeding element;
compressing the layers of the material sheet via a mechanical pressure from a transmissive roller;
emitting a laser beam through at least a portion of the transmissive roller to weld at least two layers of the material sheet;
emitting a laser beam to ablate at least a portion of the layers of the material sheet;
rolling the transmissive roller to a plurality of locations atop the additional layer of the material sheet; and
repeating the process for each successive layer of the material sheet until the object is complete.

19. The method of claim 18,
wherein the transmissive roller is coated with a substance to prevent the transmissive roller from adhering to the top layer of the material sheet being welded,
wherein said substance coating the transmissive roller is selected from the group consisting of silicone, fluoropolymers, and teflon.

20. The method of claim 18,
wherein the object has a first bond strength in a first segment and a second bond strength in a second segment,
wherein the first bond strength is different than the second bond strength,
wherein information indicative of the first bond strength and information indicative of the second bond strength were input into a computing element by a user.
